(19) United States
(12) Patent Application Publication
(10) Pub. No.: US 2002/0160074 A1
(43) Pub. Date: Oct. 31, 2002

(54) Apparatus for manufacturing resin bellows

(76) Inventors: Katsushi Saito, Osaka (JP); Mayuki Toriumi, Osaka (JP)

Correspondence Address: JORDAN AND HAMBURG LLP, 122 East 42nd Street, New York, NY, 10168, US

(21) Appl. No.: 09/801,254

(22) Filed: Mar. 7, 2001

(51) Int. Cl. B29C 49/54; B29C 49/76; B29C 49/04

(52) U.S. Cl. 425/525; 425/532

(57) ABSTRACT

The present invention provides an apparatus for manufacturing bellows which contributes to expand the life of the resin bellows to be used for vehicles and to improve the quality of the same. The apparatus for manufacturing bellows comprises a nozzle body including an annular passage and a nozzle port formed by the annular nozzle mouthpiece and the nozzle core, and a neck die having a pin and an outer surrounding body on the opposite side of the nozzle body in which the outer surrounding body abuts against the nozzle mouthpiece and the end portion of the pin projecting from the outer surrounding body abuts against the nozzle core to form a cavity for molding the neck portion in communication with the nozzle port between the pin and the outer surrounding body prior to manufacturing of the bellows, and moves away from the state being abutted against the nozzle body with the resin portion filled in the cavity crimped when manufacturing the bellows, wherein the extent of projection of the end of the pin from the outer surrounding body is determined so that the nozzle core is allowed to be displaced in the axial direction while maintaining the state being abutted against the end portion, and the boundary portion between said neck portion and the bellows body is able to be increased in thickness and quantity when filling resin into said cavity.

### BACKGROUND OF THE INVENTION

1. Field of the Invention

The present invention relates to an apparatus for manufacturing resin bellows to be mounted to the suspension device or the like of the automotive vehicle.

2. Description of the Related Art

An apparatus for manufacturing resin bellows employing press blower method, for example, an apparatus for manufacturing resin bellows 1 comprising a bellows body 2 of which the radius varies along the axis and a neck portion 3 formed at least at one end of said bellows body 2 as shown in FIG. 6 includes a nozzle body 50 and a neck die 60 disposed respectively on the upper side and the lower side facing toward each other, and an outline die 30 as shown in FIG. 7 and FIG. 8.

The nozzle body 50 includes a nozzle core 52 having a truncated-conical upper portion disposed in an annular nozzle mouthpiece 51, an annular path 53 formed between the nozzle mouthpiece 51 and the nozzle core 52 for infusing melted resin, and an annular nozzle port 54 formed at the open end thereof.

The neck die 60 is axially movable with respect to the nozzle body 50, and comprises a pin 61 as an inner die for molding the inner periphery of the neck portion and an outer surrounding body 62, and a cavity 64 for molding the neck portion is formed between the mouthpiece portion 63 of the outer surrounding body 62 and the pin 61. The lower end portion of the pin 61 slightly downward (approx. 2 mm) projects from the end surface of the outer surrounding body 62, so that the lower end portion of the outer surrounding body 62 abuts against the nozzle mouthpiece 51 and the end portion 61a abuts against the top portion 55 of the nozzle core 52 when starting manufacturing of resin bellows. The top portion 55 of the nozzle core 52 is formed with a recess 56 in which the end portion 61a of the pin 61 is abutted in the fitted state.

In addition, the outer surrounding body 62 includes a mouthpiece portion 63 circumferentially divided into a plurality of pieces, and a thin supporting plate portion 67 extending from the proximal portion of each divided piece has outward resiliency, so that the outer surrounding body 62 is supported by a holder 68 fitted on the outer periphery thereof under normal conditions and opens outwardly by the resiliency of the supporting plate portion 67 when the holder 68 is pulled upwardly for die cutting after molding. In the related apparatus, the outer surrounding body 62 is formed of nickel-chrome-molybdenum steel.

When the resin bellows are manufactured by the use of such a manufacturing apparatus, the nozzle port 54 of the nozzle body 50 is formed in communication with the cavity 64 of the neck die 60 with the outer surrounding body 62 of the neck die 60 abutted against the upper surface of the nozzle mouthpiece 51, and the end portion 61a of the pin 61 abutted against the top portion 55 of the nozzle core 52 as shown in FIG. 8. When melted resin R is infused to the passage 53 of the nozzle body 50 in this state, the resin R is filled in the cavity 64 from the nozzle port 54 as shown in FIG. 9, and then cooled and cured when it is brought into contact with the pin 61 and the outer surrounding body 62.

When the neck die 60 is pulled upward while infusing melted resin R to said passage 53 in this state, a cylindrical intermediate moldings (parison for blow molding) 6 is obtained as shown in FIG. 7. In this case, considering the configuration of the bellows 1 as a final product, the thick portions 7 and thin portions 8 of the intermediate moldings 6 can be formed alternately by varying a gap at the nozzle port 54 by the up-down movement of the nozzle core 52 according to the pulling speed of the neck die 60.

Then, before the intermediate moldings 6 is cured, the outline die 30 corresponding to the configuration of the product, that is, a bellows, is fitted from the outside, and gas is injected through the inner hole 69 of the pin 61 of the neck die 60, for example, into the intermediate moldings 6. Accordingly, the intermediate moldings expands along the configuration of the outline die and thus a resin bellows 1 shown in FIG. 6 is obtained as a product.

However, in the case of the related apparatus as shown above, when the neck die 60 is pulled upward while infusing the melted resin to the annular passage 53 of the nozzle body 50 and injecting through the nozzle port 54, the portion corresponding to the boundary portion 5 between the neck portion 3 that is already cured in the cavity 64 of the neck die 60 and uncured bellows body 2 becomes thinner by being pulled by the neck die 60. In addition, since said boundary portion 5 is bent outwardly and further pulled during the subsequent operation of blow molding, there may be formed a circumferential recessed thread 9 on the inner surface of the boundary portion 5 bent as shown in FIG. 10, whereby sufficient thickness cannot be maintained. As a consequent, the strength of the boundary portion 5 of the manufactured resin bellows is lowered and the durability is reduced, and thus it may be damaged after relatively short period of use.

Though the outer surrounding body 62 of the neck die 60 has a spring effect at the thin supporting plate portions 67 so that the dividedly formed mouthpiece 63 can open during die cutting, since the outer surrounding body 62 is formed of nickel-chrome-molybdenum steel as described above, the mechanical strength is low, and thus the portion that is subjected to repeated resilient deformation may be damaged. Therefore, durability is not sufficient, which contributes to the impairment of extension of life of the apparatus.

### SUMMARY OF THE INVENTION

With the problem described above in view, it is an object of the present invention to provide an apparatus for manufacturing bellows, which contributes to enhance the quality of the resin bellows manufactured therewith, and to provide an apparatus for manufacturing resin bellows which contributes to extension of life of the apparatus itself for manufacturing bellows.

The present invention is an apparatus for manufacturing resin bellows having a bellows body and a neck portion formed at least at one end of said bellows body, comprising: a nozzle body including a nozzle core with a truncated-conical upper portion disposed within an annular nozzle mouthpiece, and an annular passage and a nozzle port formed between said nozzle mouthpiece and said nozzle core so that the axial displacement of said nozzle core may vary the gap at the nozzle port; and a neck die including a pin disposed so as to be axially movable with respect to said nozzle body so that the end portion thereof may abut against the top portion of said nozzle core, an outer surrounding body surrounding said pin and being able to abut against said nozzle mouthpiece, and a cavity for molding neck portion that is brought into communication with said nozzle port when it is abutted against said nozzle body formed between said pin and the outer surrounding body, so as to move away from the state of being abutted against the nozzle body with the resin portion filled in said cavity held therein when manufacturing bellows, characterized in that the end portion of the pin of said neck die projects from the end surface of the outer surrounding body, the extent of projection of said end portion in the direction of axis is determined so that said nozzle core is allowed to be displaced in the axial direction while maintaining the state being abutted against said end portion, and the boundary portion between said neck portion and the bellows body is able to be increased in thickness and quantity when filling resin into said cavity.

According to an apparatus for manufacturing resin bellows of the present invention, when manufacturing bellows, the end surface of the outer surrounding body of the neck die is abutted against the nozzle mouthpiece of the nozzle body, and simultaneously, the end portion of the pin is abutted against the top portion of the nozzle core, so that the nozzle port of the nozzle body is brought into communication with the cavity for molding the neck portion of the neck die.

When melted resin is supplied to the annular passage of the nozzle body in this state, the resin is filled through the nozzle port into said cavity formed between the pin and the outer surrounding body of the neck die, and then cooled and cured by being brought into contact with the pin and the outer body.

In this case, since the end portion of the pin projects from the outer surrounding body and the extent of projection of the end portion of the pin is determined so as to allow the axial displacement of the nozzle core, the distance between the nozzle core and the opened end of the cavity can be established sufficiently by displacing the nozzle core axially inwardly of the nozzle mouthpiece with the state of being abutted against the end portion of the pin maintained and the gap at the nozzle port can be broaden, thereby increasing the quantity of resin to be injected from the nozzle port. Therefore, in the stage of filling resin into the cavity, the portion corresponding to the boundary potion between the portion corresponding to the neck portion and the bellows body outside the opened end of the cavity is increased in thickness and quantity.

Subsequently, when the neck die is moved away from the nozzle body with the resin portion in the cavity crimped between the pin and the outer surrounding body while supplying melted resin into the passage, a cylindrical intermediate moldings (parison for blow molding) is obtained. During this operation, the boundary portion between the neck portion, which is already cured, and the bellows body, which is not cured yet is pulled. However, the boundary portion has sufficient thickness as described above, there is no possibility that the thickness of the boundary portion becomes thinner than other portions.

Before the intermediate moldings described above is cured, the outline die corresponding to the configuration of the bellows as a product is applied from the outside to the intermediate moldings, and gas is injected into the intermediate moldings for blow molding. Then the intermediate moldings expands along the configuration of the outline die, and the resin bellows is obtained as a product. Even when the boundary portion between the neck portion and the bellows body is pulled outwardly during the operation of blow molding, since the boundary portion is thicker than other portions, formation of recessed thread on the inner surface thereof is prevented. Accordingly, the strength of the resin bellow is enhanced, or the condition such as the possibility of breakage in service is prevented, and the quality of manufactured resin bellows may be improved.

In the manufacturing apparatus described above, preferably, the nozzle core of the nozzle body is formed on its top portion with a recess in which the end portion of the pin projecting from the outer surrounding body of the neck die can be fitted, and the outer peripheral wall of the recess is fitted on the outer periphery of the tip portion of the pin and the nozzle core can be axially displaced as far as the fitted state can be maintained when filling resin into the cavity of the neck die.

In this arrangement, enlargement of the gap at the nozzle port by the axial movement of the nozzle core when the resin is filled into the cavity, in other words, increase in thickness and quantity at the boundary portion between the neck portion and the bellows body, is realized without problem.

Especially, the larger the extent of projection of the pin (projecting size) from the end portion of the outer surrounding body, the larger the fitting size on the outer peripheral wall on the top of the nozzle core would be.

In the apparatus for manufacturing the resin bellows, the outer surrounding body of the neck die is preferably formed of hardened stainless steel.

In this arrangement, the mechanical strength of the outer surrounding body is increased, thereby preventing breakage in service and extending the life of the manufacturing apparatus.

Especially preferably, the outer surrounding body is divided circumferentially at the mouthpiece portion on the distal end into a plurality of pieces and each thin supporting plate portion has outward resiliency and be reopenable by the sliding movement of the holder fitted on the outer periphery thereof.

In other words, at the time of die-cutting after molding, the molded bellows can be taken out easily by opening the outer surrounding body by sliding the holder, and the strength of the supporting plate portion, which is subjected to repetitive resilient deformation in association with molding and die-cutting, is enhanced, which leads to the extended life thereof.

### BRIEF DESCRIPTION OF THE DRAWINGS

FIG. 1 is a cross sectional view showing the principal portion of the neck die and the nozzle body of an apparatus for manufacturing resin bellows according to an embodiment of the present invention;

FIG. 2 is a schematic bottom view showing the opened state of the outer surrounding body of the neck die;

FIG. 3 is a cross sectional view of the principal portion showing a state where the neck die and the nozzle body are abutted with respect to each other;

FIG. 4 is an enlarged cross sectional view showing a part of the neck die prior to the movement away from the nozzle body at the time of manufacturing a bellows by the use of the same apparatus;

FIG. 5 is an enlarged cross sectional view showing a part of the bellows manufactured by the use of the same apparatus;

FIG. 6 is a cross sectional view showing an example of the resin bellows to be manufactured;

FIG. 7 is a cross sectional view showing a state in which the bellows is being manufactured by the apparatus according to the related art;

FIG. 8 is a partial cross sectional view showing a state in which the neck die and the nozzle body is abutted with respect to each other in the apparatus according to the related art;

FIG. 9 is an enlarged cross sectional view showing a part of the neck die prior to the movement away from the nozzle body when the bellows is manufactured by the apparatus according to the related art; and

FIG. 10 is an enlarged cross sectional view showing a part of the bellows manufactured by the apparatus according to the related art.

### DETAILED DESCRIPTION OF THE PREFERRED EMBODIMENTS

Referring now to the drawings, the preferred embodiments of an apparatus for manufacturing resin bellows according to the present invention will be illustrated.

The resin bellows to be manufactured (hereinafter referred to as bellows) will be described. The bellows 1 of this embodiment is formed of thermoplastic synthetic resin material, and comprises a bellows body 2 of which radius varies along the axis, and neck portions 3, 4 formed on both ends of the bellows body 2 as shown in FIG. 6. Reference numeral 5 designates a boundary portion between one of the neck portions 3 and the bellows body 2.

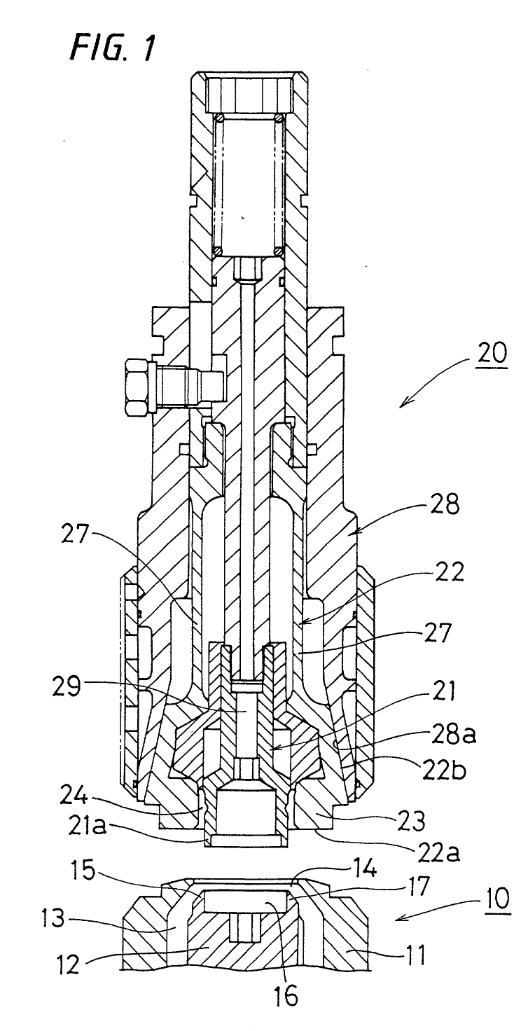

Referring now to FIG. 1 to FIG. 5, the construction of the apparatus for manufacturing bellows will be generally described.

This manufacturing apparatus comprises a nozzle body 10 and neck die 20 opposed with respect to each other along the axis thereof.

The nozzle body 10 includes a nozzle core 12 having the top portion in the truncated conical shape disposed within the annular nozzle mouthpiece 11 with a prescribed space kept therearound, so that an annular passage 13 and a nozzle port 14 to which melted resin R is infused are formed between the nozzle mouth piece 11 and the nozzle core 12. The inner surface of the upper portion of the nozzle mouthpiece 11 corresponding to the truncated conical portion of the nozzle core 12 is tapered, so that the annular passage 13 is connected to the nozzle port 14 in the inclined state.

The nozzle core 12 is disposed in such a manner that it can be displaced axially with respect to the nozzle mouthpiece 11 by means of a suitable to-and-fro driving means, so that the displacement can vary the gap of said nozzle port 14. In this arrangement, when manufacturing the bellows, variable adjustment of said gap enables formation of thick portion 7 and thin portion 8 on the intermediate moldings 6.

The top portion 15 of said nozzle core 12 is formed with a recess portion 16 having a sufficient depth in which the end portion 21a of the pin 21 of the neck die 20 described later can be fitted. Reference numeral 17 designates the outer peripheral wall of said recess 16.

On the other hand, the neck die 20 is movable in the direction of axis (up and down direction) with respect to said nozzle body 10 by the suitable driving means and provided so as to be abutted against the nozzle body 10. The neck die 20 comprises a pin (blow pin) 21 having the structure described below and a outer surrounding body 22 surrounding the pin 21 and is formed with a cavity 24 for molding the neck portion between the mouthpiece portion 23 at the lower end of the surrounding body 22 opposing the nozzle body 10 and said pin 21. On the portion of the pin 21 forming the inner wall of the cavity 24 is formed with a recessed thread 25 to form the projecting thread 3a on the inner peripheral surface of the neck portion 3.

Said pin 21 is formed in such a manner that the end portion 21a opposing to the nozzle body 10 projects from the end surface 22a of the outer surrounding body 22, so that when the neck die 20 is moved (lowered) toward the nozzle body prior to manufacturing of the bellows, it abuts the top portion 15 of the nozzle core 12 with said end portion 21a fitted into the recess 16. In other words, the inner peripheral wall 17 of the recess 16 of the nozzle core 12 is fitted on the outer periphery of said end portion 21a. In the figure, the outer peripheral portion on the tip of the projected end portion 21a is slightly tapered so that it can be fitted smoothly into said recess 16. Simultaneously with abutment between said pin 21 and the nozzle core 12, the end surface 22a of the outer surrounding portion 22 abuts against the upper surface of the nozzle mouthpiece 11. Accordingly, said cavity 24 brought into communication with the nozzle port 14 of said nozzle body 10 so that melted resin R injected from the nozzle port 14 can be filled within said cavity 24. Since the outer diameter of said cavity 24 is slightly smaller than the outer diameter of said nozzle port 14, the opened end of the mouthpiece portion 23 of said outer surrounding body 22 is slightly notched 26.

Here, the extend of projection L1 of the end portion 21a of said pin 21 from the outer surrounding body 22 is determined so as to allow the axial displacement of said nozzle core 12 to some extent while keeping the state being abutted with said end portion 21a, whereby the gap at the nozzle port 14 positioned at the outside of the opened end of said cavity 24 can be broadened so that this portion can be increased in thickness and quantity.

On the other hand, in the state where the end portion 21a of said pin 21 abuts against the top portion 15 of the nozzle core 12 as described above, the larger said extent of projection L1, the more the nozzle core 12 can be displaced axially inwardly with respect to the opened end of the nozzle mouthpiece 11. For example, the nozzle core 12 can be axially displaced as far as the outer peripheral wall 17 of the top portion 15 is maintained in the state of being fitted with respect to said end portion 21a, so as to establish the distance to the opened end of the cavity 24 longer.

In this regard, while the extent of projection in the related art is just about 2 mm or the like, it is determined to be more or less 6 mm in the embodiment of the present invention.

The neck die 20 is adapted to be moved away from the nozzle body 10 when manufacturing the bellows 1 so as to realize the action to crimp the resin portion filled in the cavity 24 between the pin 21 and the outer surrounding body 22 to pull it up.

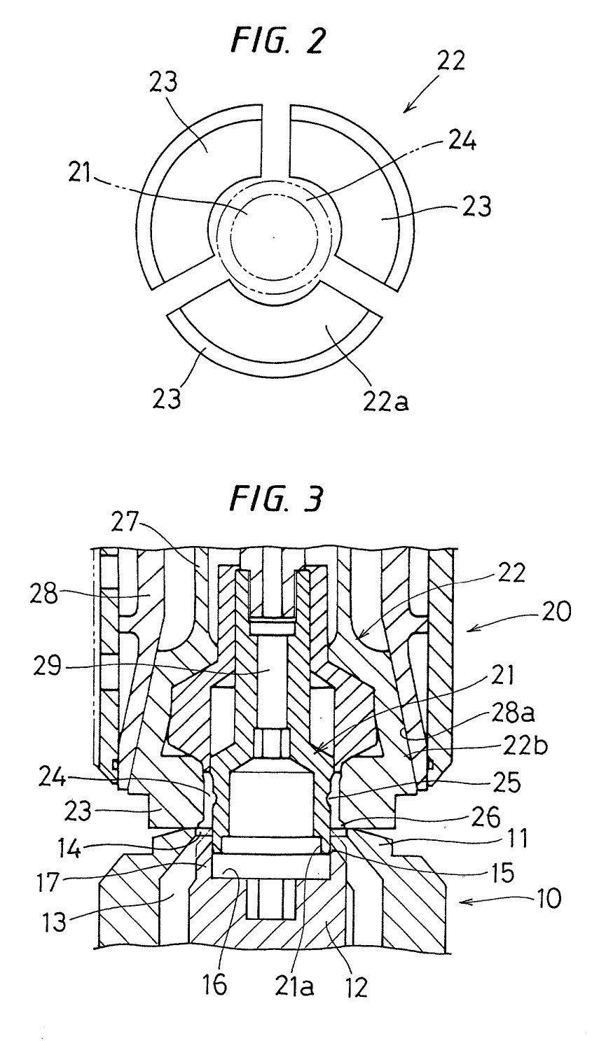

In addition, said outer surrounding body 22 is, as shown in FIG. 2, formed in such a manner that the mouthpiece portion 23 on the tip side is circumferentially divided into a plurality of portions, for example, into three portions as shown in the figure and the proximal portion of each divided portion is formed as a thin supporting plate portion 27, which gives outward resiliency for being supported. The outside of the outer surrounding portion 22 is fitted with the holder 28 having a tapered surface portion 28a corresponding to the tapered surface portion 22b of the outer periphery of the outer surrounding body so as to be slidable in the direction of axis. In this arrangement, the outer surrounding body 22 is held in the closed state (the state shown by the dotted line in FIG. 2) by the holder 28 described above under normal service and adapted to open outwardly by the resilient force of the supporting plate portion 27 by the upward sliding movement of the holder 28 upon die-cutting.

In this embodiment, the outer surrounding body 22 is formed of hardened stainless steel of SUS J2 as a single unit. Therefore, the strength and durability of the thin supporting plate portion 27 which is subjected to repetitive resilient deformation is enhanced, which leads to the extended life of the outer surrounding body 22, and thus of the manufacturing apparatus.

Though the pin 21 of the neck die 20 has an inner hole 29 for blowing gas in during blow molding, it is also possible to implement by blowing gas from the side of the nozzle core 12.

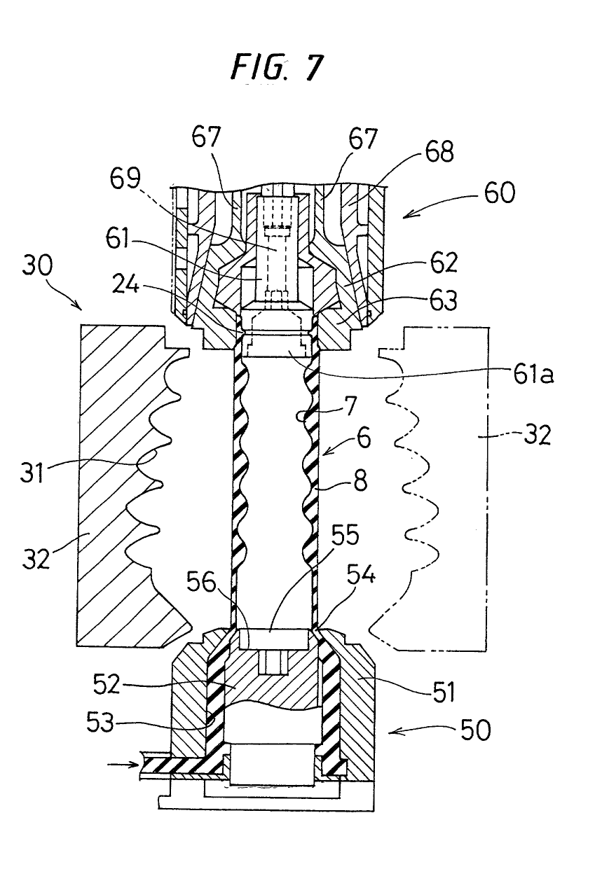

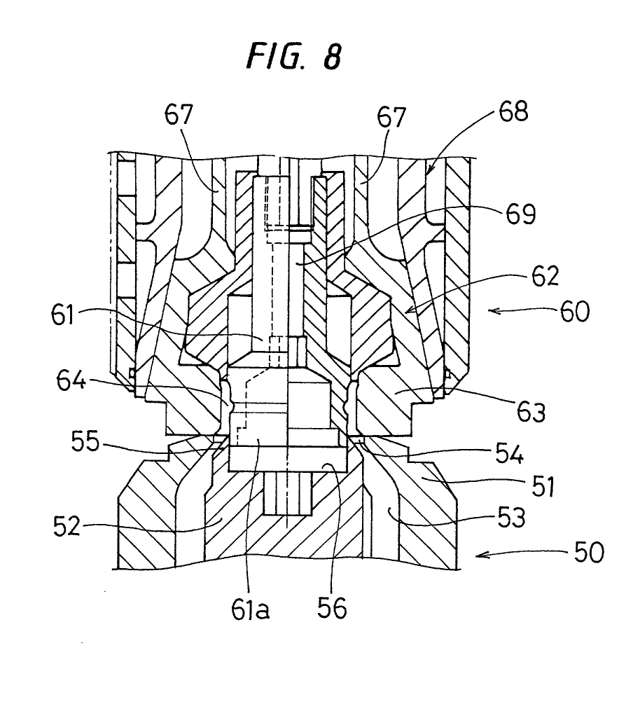

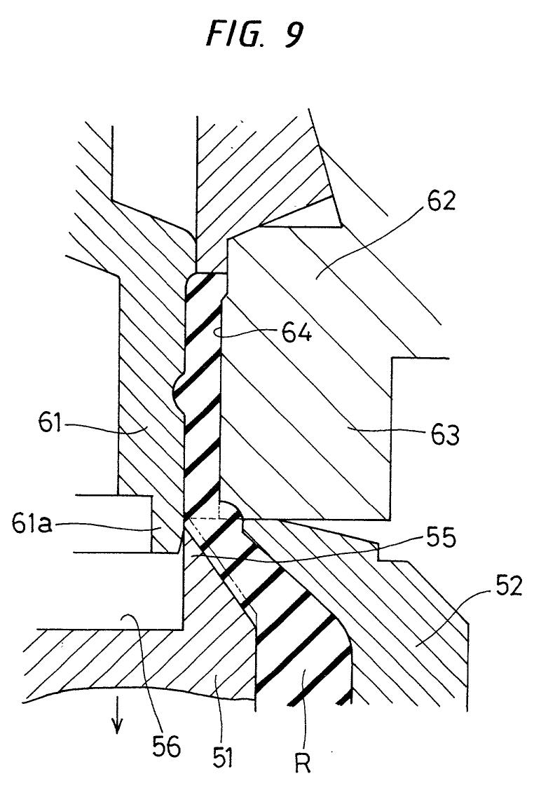

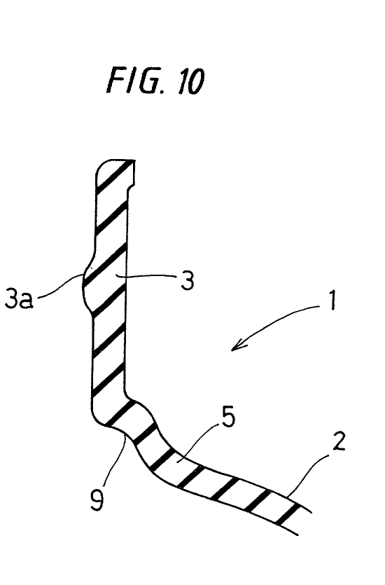

In the apparatus for manufacturing bellows described above, there is provided an outline die 30 that surrounds the formed intermediate moldings 6 from the outside as in the case of the related apparatus shown in FIG. 7. The outline die 30 includes forming surface 31 of a configuration corresponding to the outline of the bellows body 2 on the inner peripheral surface, and is constituted by a plurality of movable die portions 32 divided circumferentially into at least two portions. Each movable die portion 32 is adapted to be radially and reciprocally movable both ways. In FIG. 7, one of the movable die portions 32 is shown by a solid line and the other is shown by a phantom line for convenience.

When the bellows 1 is manufactured by the use of such a manufacturing apparatus, the neck die 20 is moved to the side of the nozzle body 10, and the end surface 22a of the outer surrounding body 22 of the neck die 20 is abutted against the nozzle mouthpiece 11 of the nozzle body 10 as shown in FIG. 3, and the end portion 21a of the pin 21 projecting from the end surface 22a is fitted to the recess 16 on the top portion 15 of the nozzle core 12. In this arrangement, the nozzle port 14 of the nozzle body 10 is brought into communication with the neck portion molding cavity 24 of the neck die 20.

When melted resin is infused into the annular passage 13 of the nozzle body 10 in this state, the resin is filled through the nozzle port 14 to the cavity 24 of the neck die 20 between the pin 21 and the outer surrounding body 22, and then cooled down and cured by being brought into contact with the pin 21 and the outer surrounding body 22.

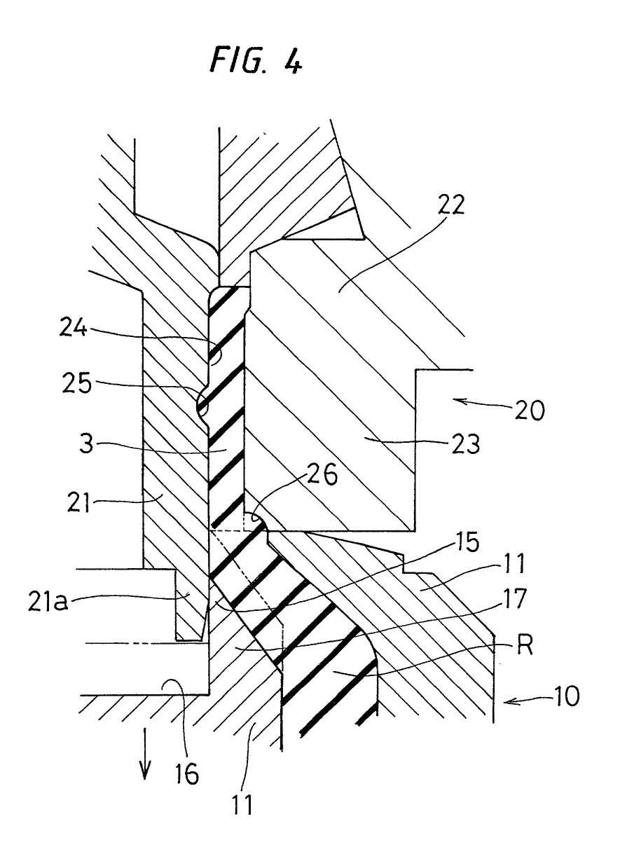

Then, the nozzle core 12 being fitted and abutted with respect to the end portion 21a of the pin 21 is axially displaced inwardly of the nozzle mouthpiece 11 with the fitted and abutted state maintained (the state shown by a solid line in FIG. 4) to increase the distance from the opened end of the cavity 24 and broaden the gap of the nozzle port 14. In this arrangement, in the state of filling resin into the cavity 24, the amount of resin to be injected from the nozzle port 14 can be increased and thus the portion corresponding to the boundary portion 5 between the neck portion 3 and the bellows body 2 can be increased in thickness and quantity.

When the neck die 20 is moved away from the nozzle body 10 with the resin portion in the cavity 24 crimped between the pin 21 and the outer surrounding body 22 in this state while further supplying melt resin R into the passage 13, the cylindrical intermediate moldings (parison for blow molding) is obtained. At this time, though the boundary portion 5 between the portion corresponding to the neck portion 3, which is already cured, and the bellows body 2, which is not cured yet is pulled, since the boundary portion 5 is formed in sufficient thickness as described before, there is no possibility that the thickness of the boundary portion 5 becomes thinner than other portions.

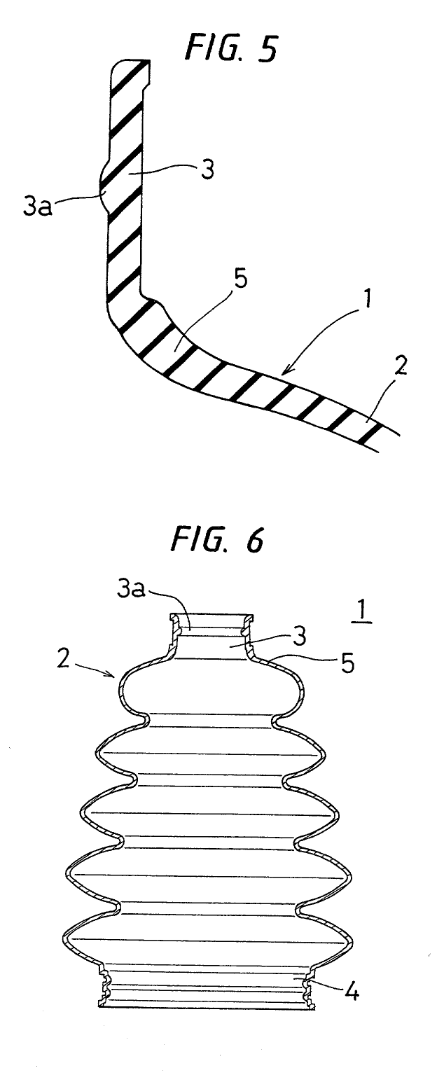

Before the intermediate moldings 6 is cured, the outline die 30 corresponding to the configuration of the bellows as a product is applied from the outside to the intermediate moldings 6 as in the case of the related apparatus shown in FIG. 7, and gas is injected into the intermediate moldings for blow molding. Then the intermediate moldings expands along the configuration of the outline die, and the resin bellows is obtained as a product. Even when the boundary portion 5 between the neck portion 3 and the bellows body 2 is pulled outward during the operation of blow molding, since the boundary portion 5 is thicker than other portions, a sufficient thickness as shown in FIG. 5 is established, thereby preventing formation of recessed thread on the inner surface thereof.

Accordingly, the strength of the resin bellows 1 is enhanced, the possibility of breakage in service is prevented, and the quality of manufactured resin bellows 1 may be improved.

Since the outer surrounding body 22 is formed of hardened stainless steel, the mechanical strength of the outer surrounding body 22 is increased, thereby preventing breakage in service and extending the life of the manufacturing apparatus.

The present invention is not limited to the embodiment described above, and various changes and modifications may be made in the invention without departing from the spirit and scope thereof.

What is claimed is:

1. An apparatus for manufacturing resin bellows having a bellows body and a neck portion formed at least at one end of said bellows body, comprising:
a nozzle body including a nozzle core with a truncated-conical upper portion disposed within an annular nozzle mouthpiece, and an annular passage and a nozzle port formed between said nozzle mouthpiece and said nozzle core so that the axial displacement of said nozzle core may vary the gap at the nozzle port; and
a neck die including a pin disposed so as to be axially movable with respect to said nozzle body so that the end portion thereof may abut against the top portion of said nozzle core, an outer surrounding body surrounding said pin and being able to abut against said nozzle mouthpiece, and a cavity for molding neck portion that is brought into communication with said nozzle port when it is abutted against said nozzle body formed between said pin and the outer surrounding body, so as to move away from the state of being abutted against the nozzle body with the resin portion filled in said cavity held therein when manufacturing bellows,
characterized in that the end portion of the pin of said neck die projects from the end surface of the outer surrounding body, the extent of projection of said end portion in the direction of axis is determined so that said nozzle core is allowed to be displaced in the axial direction while maintaining the state being abutted against said end portion, and the boundary portion between said neck portion and the bellows body is able to be increased in thickness and quantity when filling resin into said cavity.

2. An apparatus for manufacturing resin bellows according to claim 1, characterized in that the nozzle core of the nozzle body is formed on its top portion with a recess in which the end portion of the pin projecting from the outer surrounding body of the neck die can be fitted, and the outer peripheral wall of the recess is fitted on the outer peripheral wall of the tip portion and the nozzle core can be axially displaced as far as the fitted state can be maintained when filling resin into the cavity of the neck die.

3. An apparatus for manufacturing resin bellows according to claim 1, characterized in that the outer surrounding body of the neck die is formed of hardened stainless steel.

4. An apparatus for manufacturing resin bellows according claim 3, characterized in that said outer surrounding body is divided circumferentially at the mouthpiece portion on the distal end thereof into a plurality of pieces and each thin supporting plate portion has outward resiliency and be reopenable by the sliding movement of the holder fitted on the outer periphery thereof.
